(19) United States
(12) Patent Application Publication
(10) Pub. No.: US 2025/0328421 A1
(43) Pub. Date: Oct. 23, 2025

(54) CONTROLLER AND MEMORY SYSTEM

(71) Applicant: SK hynix Inc., Icheon-si (KR)

(72) Inventors: Myoung Seo KIM, San Jose, CA (US); Jae Woong LEE, San Jose, CA (US); Jong Ryool KIM, San Jose, CA (US); Hane YIE, San Jose, CA (US); Byung Il KOH, Icheon-si (KR); Soo Yong LIM, San Jose, CA (US)

(21) Appl. No.: 18/829,125

(22) Filed: Sep. 9, 2024

Related U.S. Application Data
(60) Provisional application No. 63/636,474, filed on Apr. 19, 2024.

(30) Foreign Application Priority Data
Jun. 10, 2024 (KR) 10-2024-0075056

(51) Int. Cl. G06F 11/10

(52) U.S. Cl. CPC G06F 11/1068; G06F 11/1016

(57) ABSTRACT

Controllers and memory systems are disclosed. In some embodiments of the disclosed technology, by designating, as a shared memory area, a portion of a memory area in a memory device included in a memory system used by a plurality of host devices and managing the access and operations of the plurality of host devices to the shared memory area, it is possible to improve the usage efficiency of the memory area and prevent errors arising from the access of the plurality of host devices to the shared memory area.

### PRIORITY CLAIM AND CROSS-REFERENCE TO RELATED APPLICATIONS

This patent document claims the priority and benefits of U.S. Provisional Application No. 63/636,474, filed on Apr. 19, 2024, and Korean Patent Application No. 10-2024-0075056, filed on Jun. 10, 2024. The entire content of the aforementioned patent application is incorporated by reference as part of the disclosure of this patent document.

### BACKGROUND

### Technical Field

Various embodiments of the disclosed technology generally relate to a controller and a memory system.

### Background

A computing system may perform data processing using a processor and a memory. For example, the processor may perform data processing using a memory located inside the computing system.

In some cases, the processor may perform data processing using a memory located outside the computing system. The performance of data processing can be enhanced by the processor utilizing both the memory located inside the computing system and the memory located outside the computing system.

The memory located outside the computing system may be used by a plurality of computing systems. In such cases, the memory must be utilized efficiently.

### SUMMARY

The disclosed technology can be implemented in some embodiments to prevent memory errors and to improve the efficiency of memory usage when a plurality of host devices use a memory located outside the host devices.

In an embodiment, a memory system may include: one or more memory devices, each memory device including a first memory area and a second memory area, wherein a number of host devices that are accessible to the first memory area is equal to or greater than a number of host devices that are accessible to the second memory area; and a controller configured to, upon receiving a first command for a first address included in the first memory area, control an operation according to the first command based on an indirect mapping table that includes: shared status information indicating a shared status of the first address to indicate whether the first address is a memory area that is shared by a plurality of host devices or dedicated to a specific host device; accessibility status information indicating whether a specific host device is accessible to the first address; and overwrite status information indicating usage statuses of at least two data areas corresponding to the first address to indicate whether data in the at least two data areas is overwritten data.

In an embodiment, a memory system may include: one or more memory devices, each memory device including a first memory area and a second memory area; and a controller configured to: control, upon receiving a first command for a first address included in the first memory area, an operation according to the first command based on an indirect mapping table that includes information on at least two data areas in the first memory area corresponding to the first address; and control, upon receiving a second command for a second address included in the second memory area, an operation according to the second command on one data area in the second memory area corresponding to the second address.

In an embodiment, a controller may include: an internal memory device configured to store an indirect mapping table including shared status information, accessibility status information and overwrite status information for at least a part of a memory area included in an external memory device; and a control circuit configured to: upon receiving a command from an external device, check the shared status information, the accessibility status information and the overwrite status information corresponding to an address according to the command in the indirect mapping table; and perform an operation according to the command on the external memory device.

In an embodiment, a memory system may include: at least one memory including a first memory area and a second memory area, wherein the number of host devices which are accessible to the first memory area is equal to or greater than the number of host devices which are accessible to the second memory area; and a controller configured to, when receiving a first command for a first address included in the first memory area, control an operation according to the first command based on an indirect mapping table including shared status information indicating a shared status of the first address, accessibility status information indicating a device which is accessible to the first address and overwrite status information indicating usage statuses of at least two data areas corresponding to the first address.

In an embodiment, a memory system may include: at least one memory including a first memory area and a second memory area; and a controller configured to control, when receiving a first command for a first address included in the first memory area, an operation according to the first command based on an indirect mapping table including information on at least two data areas corresponding to the first address, and control, when receiving a second command for a second address included in the second memory area, an operation according to the second command on one data area corresponding to the second address.

In an embodiment, a controller may include: an internal memory configured to store an indirect mapping table including shared status information, accessibility status information and overwrite status information for at least a part of a memory area included in an external memory; and a control circuit configured to check, when receiving a command from an outside, the shared status information, the accessibility status information and the overwrite status information corresponding to an address according to the command in the indirect mapping table, and perform an operation according to the command on the external memory.

In some embodiments of the disclosed technology, each of a plurality of host devices device may be independently allocated or at least two host devices may share at least a part of a memory area included in a memory located outside the plurality of host devices, thereby improving the efficiency of memory use.

### BRIEF DESCRIPTION OF THE DRAWINGS

FIG. 1 is a diagram illustrating an example configuration of a memory system based on an embodiment of the disclosed technology.

FIG. 2 is a diagram illustrating an example of the memory system that provides a shared memory area based on an embodiment of the disclosed technology.

FIG. 3 is a diagram illustrating an example of an indirect mapping table by which the memory system manages access to a shared memory area based on an embodiment of the disclosed technology.

FIGS. 4 to 6 are diagrams illustrating an example method by which the memory system handles read commands based on an embodiment of the disclosed technology.

FIGS. 7 to 9 are diagrams illustrating an example method by which the memory system handles write commands based on an embodiment of the disclosed technology.

FIG. 10 is a diagram illustrating an example of the memory system that manages access to a non-shared memory area based on an embodiment of the disclosed technology.

### DETAILED DESCRIPTION

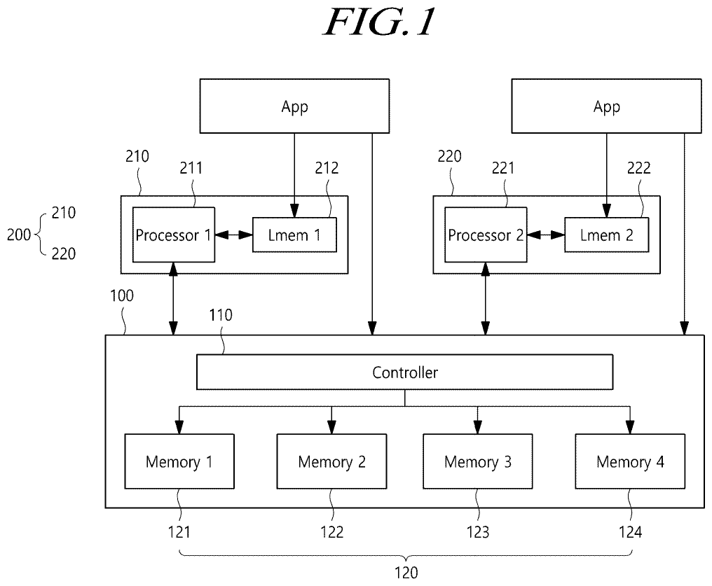

FIG. 1 is a diagram illustrating an example configuration of a memory system 100 based on an embodiment of the disclosed technology.

Referring to FIG. 1, the memory system 100 based on an embodiment of the disclosed technology may include at least one memory 120. FIG. 1 illustrates as an example a case where the memory system 100 includes four memories 121, 122, 123 and 124, but the disclosed technology is not limited thereto.

The at least one memory 120 may be, for example, a volatile memory such as a DRAM, an SDRAM, a DDR SDRAM and an LPDDR SDRAM, but the disclosed technology is not limited thereto.

In some implementations, the at least one memory 120 may be a nonvolatile memory such as a NAND flash memory, a 3D NAND flash memory and a NOR flash memory. In addition, in some implementations, one part of the memory 120 included in the memory system 100 may be a volatile memory, and the other part may be a nonvolatile memory.

The memory 120 may be one of various types of memories such as a resistive RAM, a phase change memory, a magnetoresistive memory, a ferroelectric memory and a spin transfer torque random access memory. In some implementations, the memory 120 may be a processing-in-memory which includes a calculation function or a data processing function.

The memory system 100 may include a controller 110 that manages the memory 120.

The controller 110 may manage the operation of the memory 120 while communicating with the outside. The controller 110 may control read and write operations on the memory 120 while managing the operation of the memory 120.

Alternatively, in addition to the controller 110, a separate memory controller that manages read and write operations on the memory 120 may be disposed in the memory system 100. For example, a memory controller corresponding to each of the plurality of memories 121, 122, 123 and 124 may be disposed in the memory system 100. A memory controller may control read and write operations on the memory 120. In this case, the controller 110 may manage the state or operation of the memory 120 while communicating with the memory controller.

The memory system 100 may operate while communicating with a computing system or a host device 200 located outside. In some implementations, the host device 200 and the memory system 100 may be collectively regarded as a computing system.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a mobility device (e.g., a vehicle, a robot or a drone) capable of traveling under human control or autonomous driving, or the like. Alternatively, the host device 200 may be a virtual/augmented reality device which provides a 2D or 3D virtual reality image or augmented reality image. Besides, the host device 200 may be any one of various electronic devices each of which requires the memory system 100 capable of storing data.

A plurality of host devices 200 may use the memory system 100. For example, a first host device 210 and a second host device 220 may use the memory system 100.

Each of the plurality of host devices 200 may include a processor and a local memory. The local memory may be the same type of memory as the memory 120 included in the memory system 100, or may be a different type of memory.

The first host device 210 may include a first processor 211 and a first local memory 212. The second host device 220 may include a second processor 221 and a second local memory 222.

The first processor 211 may perform data processing using the first local memory 212. In addition, the first processor 211 may perform data processing using at least a part of the memory 120 included in the memory system 100.

The second processor 221 may perform data processing using the second local memory 222. In addition, the second processor 221 may perform data processing using at least a part of the memory 120 included in the memory system 100.

Each of the plurality of host devices 200 may perform data processing using a local memory included in the host device 200 and the memory system 100 located outside. Since an application to be driven in the host device 200 operates using a local memory inside the host device 200 and the memory system 100 outside the host device 200, the operational performance of the application may be improved.

The host device 200 may perform communication with the memory system 100 through a preset interface.

For example, the host device 200 may communicate with the memory system 100 through the Compute Express Link (CXL) interface. The host device 200 may be set as a CXL root port, and the memory system 100 may be set as a CXL end point.

Since the host device 200 communicates with the memory system 100 through the CXL interface, an environment in which latency is reduced and is accessible using a high bandwidth may be provided in a structure that communicates with the memory system 100 of high capacity. Since the communication speed between the host device 200 and the memory system 100 is improved, the host device 200 may efficiently perform data processing using the internal local memory and the external memory system 100.

Alternatively, in some implementations, the host device 200 may communicate with the memory system 100 through an interface other than the CXL interface. For example, the host device 200 and the memory system 100 may communicate through at least one among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol and an IDE (integrated drive electronics) protocol, but are not limited thereto.

Since the host device 200 performs data processing using the internal local memory and, when necessary, performs data processing using the memory system 100 located outside, data processing performance may be improved.

Since the plurality of host devices 200 share and use the memory system 100, the memory 120 included in the memory system 100 may be efficiently used. In some implementations, by managing a part of the memory 120 included in the memory system 100 as an area that may be shared and used by at least two host devices 200, the performance of performing a workload to be performed by the plurality of host devices 200 may be increased.

The memory 120 of the memory system 100 may be used as a pooled memory or a shared fabric-attached memory. A host-managed device memory (HDM) which is exposed from the memory system 100 supporting the plurality of host devices 200 may be referred to as a fabric-attached memory. A fabric-attached memory which is exposed from a logical device may be referred to as a logical device fabric-attached memory (LD-FAM). A fabric-attached memory which is exposed to a larger scheme using a port-based routing (PBR) link may be referred to as a global fabric-attached memory (G-FAM).

A fabric-attached memory in which each host-managed device memory area is used by being dedicated to a single host interface may be referred to as a “pooled memory” or a “pooled fabric-attached memory.” A fabric-attached memory which is set so that a plurality of host interfaces may simultaneously access a single host-managed device memory area may be referred to as a “shared fabric-attached memory.” A different shared fabric-attached memory area may be set to support different setting of a host interface.

The logical device fabric-attached memory may include various modifications. A multi-logical device (MLD) may expose a plurality of logical devices through a single shared link. A multi-headed single logical device (MH-SLD) may expose a plurality of logical devices each with a dedicated link. A multi-headed multi-logical device (MH-MLD) may include a plurality of links each of which supports the operation of a multi-logical device or a single logical device (which may be selectively set). At least one link may support the operation of a multi-logical device.

A global fabric-attached memory device may be designed as at least one link that supports a plurality of host/peer interfaces. The host interface of an incoming CXL.mem or UIO request may be determined by a source PBR ID (SPID) field included in a port-based routing (PBR) message.

The multi-headed single logical device and the multi-headed multi-logical device may be distinguished from any multi-port configuration which supports a plurality of CPU topologies in a single OS domain.

A coherency model for each shared host-managed device memory DB area may be specified as multi-host hardware coherency or software-managed coherency by FM.

The multi-host hardware coherency may require multi-logical device hardware which tracks a host coherency state defined for each cache line for some various degrees that rely on the implementation-specific tracking mechanism of a multi-logical device which may typically be categorized as a snoop filter or a global directory. Each host device 200 may perform an arbitrary atomic operation that is supported by an instruction-set architecture (ISA), by obtaining an exclusive access to a cache line and performing an atomic operation in a cache. Data may be observed globally using cache coherency, and may follow a general hardware cache eviction flow. A MemWr command for a memory area may set an SnpType field to No-Op to prevent deadlock. The host device 200 may need to acquire ownership using an M2S request channel before executing an MemWr result within two phases to complete write. This may be a requirement for a hardware coherency model in a shared fabric-attached memory and a direct P2P CXL.mem.

The shared fabric-attached memory may expose the memory 120 to the host device 200 as a single host-managed device memory. A software coherency model may be supported between the host devices 200.

Software management coherency may not require that a multi-logical device tracks a host coherency state. Software on each host device 200 may use a software-specific mechanism to coordinate the software ownership of each cache line. Software may choose to rely on multi-host hardware coherency in a different host-managed device memory area so as to coordinate the software ownership of a cache line in a software management coherency host-managed device memory area. Other mechanisms for software to coordinate cache line ownership may be included within the scope of the present specification.

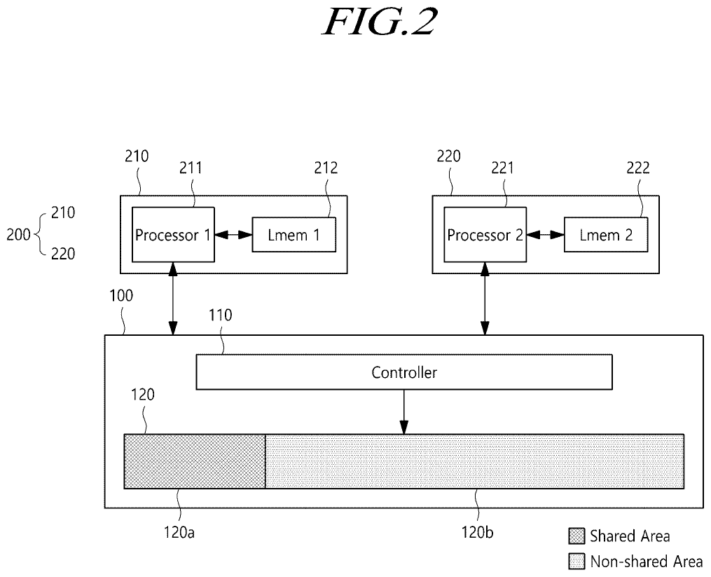

FIG. 2 is a diagram illustrating an example of the memory system 100 that provides a shared memory area based on an embodiment of the disclosed technology.

Referring to FIG. 2, the first host device 210 and the second host device 220 may perform data processing using the memory system 100. FIG. 2 illustrates as an example a case where two host devices 200 use the memory system 100, but the number of host devices 200 that use the memory system 100 may be three or more.

The first processor 211 of the first host device 210 may perform data processing using the first local memory 212 and at least a part of the memory 120 included in the memory system 100. The second processor 221 of the second host device 220 may perform data processing using the second local memory 222 and at least a part of the memory 120 included in the memory system 100.

The controller 110 of the memory system 100 may provide memory areas to the first host device 210 and the second host device 220 while managing the memory areas included in the memory 120.

The controller 110 may manage separately and collectively the memory areas included in the plurality of memories 120. FIG. 2 illustrates an example in which the memory areas included in the four memories 121, 122, 123 and 124 illustrated in FIG. 1 are managed collectively, but the disclosed technology is not limited thereto.

The controller 110 may allocate at least a part of the memory areas included in the memory 120 to one host device 200.

For example, when receiving a memory area allocation request from a host device 200, the controller 110 may allocate a part of the memory areas to the host device 200. An allocated memory area may be used by the host device 200 that has transmitted the allocation request. An access by the other host device 200 to the corresponding memory area may be inhibited.

The controller 110 may manage at least a part of the memory areas included in the memory 120 so that the at least a part of the memory areas is shared and used by at least two host devices 200.

For example, the controller 110 may manage a part of the memory areas according to a request from a host device 200 so that the part of the memory areas is accessible by at least two host devices 200. For instance, the controller 110 may receive a memory area allocation request from the first host device 210. The controller 110 may receive a memory area share request from the first host device 210.

The controller 110 may manage a memory area allocated to the first host device 210, as a memory area that is accessible by the other host device 200.

The controller 110 may manage the corresponding memory area by setting the corresponding memory area to a state in which the other host device 200 may perform a read operation on the corresponding memory area. Alternatively, the controller 110 may manage the corresponding memory area by setting the corresponding memory area to a state in which the other host device 200 may perform a read operation and a write operations on the corresponding memory area.

The controller 110 may manage a host device 200 that is accessible to the corresponding memory area, based on information received from the first host device 210 which has requested the sharing of the corresponding memory area.

For example, the first host device 210 may transmit, to the memory system 100, a request to share a memory area. The first host device 210 may transmit, to the memory system 100, a request to allow the second host device 220 to access the corresponding memory area.

According to the request of the first host device 210, the controller 110 may set and manage the corresponding memory area to and in a state in which the second host device 220 is accessible to the corresponding memory area. An access right (e.g., a read right or read and write rights) of the second host device 220 to the corresponding memory area may also be managed based on a request received from the first host device 210.

For another example, the controller 110 may manage a part of the memory areas included in the memory 120 by setting the part of the memory areas as a shareable memory area. The controller 110 may manage memory areas by setting a part of the memory areas to a sharable memory area and setting the rest as a non-sharable memory area.

The controller 110 may manage the memory areas included in the memory 120 by dividing the memory areas into a first memory area 120a and a second memory area 120b.

The first memory area 120a may be a shared memory area which is accessible by at least two host devices 200. The second memory area 120b may be a non-shared memory area which is accessible by only one host device 200. The number of host devices 200 that are accessible to the first memory area 120a may be equal to or greater than the number of host devices 200 that are accessible to the second memory area 120b.

The size of the first memory area 120a may be smaller than the size of the second memory area 120b, but the disclosed technology is not limited thereto. A memory area and a size corresponding to the first memory area 120a may be managed by being fixed, or may be managed by being varied depending on a usage status.

The controller 110 may control an access to the first memory area 120a according to requests from at least two host devices 200.

The controller 110 may allocate at least a part of the second memory area 120b according to the request of each of at least two host devices 200. The controller 110 may manage only a corresponding host device 200 so that only the corresponding host device 200 accesses an allocated memory area.

The controller 110 may set and manage a separate table to control an access of a host device 200 to the first memory area 120a and to process a command from the host device 200.

When an allocation request or an access request from a host device 200 for the first memory area 120a is generated, the controller 110 may manage the access and operation of the host device 200 to and on the first memory area 120a using the set table.

The form of the table for the controller 110 to manage an access to the first memory area 120a may be various.

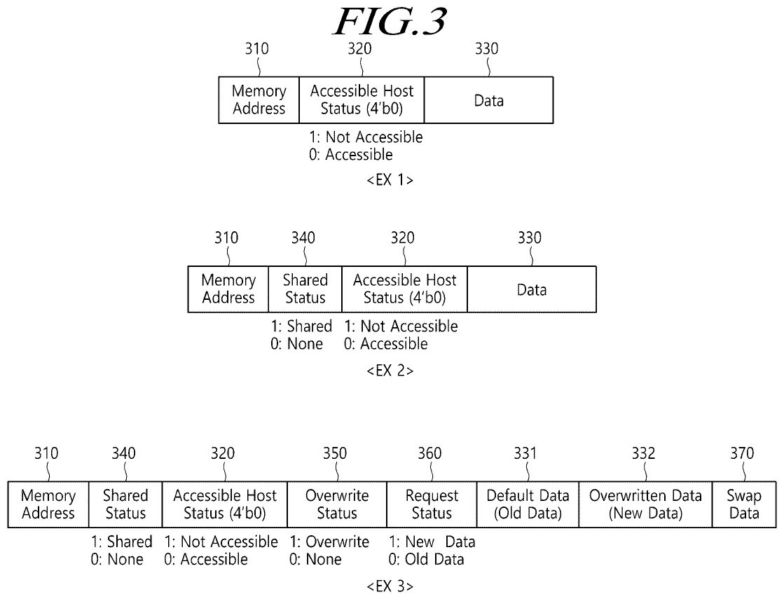

FIG. 3 is a diagram illustrating an example of an indirect mapping table by which the memory system 100 manages access to a shared memory area based on an embodiment of the disclosed technology.

Referring to FIG. 3, the controller 110 of the memory system 100 may manage the access and operation of the host device 200 to and on the first memory area 120a of the memory 120 using the indirect mapping table. For example, the controller 110 may perform management of the first memory area 120a using the indirect mapping table, or may perform management of the first memory area 120a and the second memory area 120b using the indirect mapping table.

The controller 110 may set the indirect mapping table including information on an address included in the first memory area 120a and a host device 200 that is accessible to the corresponding address.

For example, as in <EX 1>, the indirect mapping table may include an address information field 310 and an accessibility status information field 320.

The address information field 310 may include information on an address included in the first memory area 120a.

The accessibility status information field 320 may include information on a device that is accessible to the corresponding address.

For example, if accessibility status information includes a first accessibility status value, it may mean that the corresponding host device 200 is accessible to the corresponding address. If the accessibility status information includes a second accessibility status value, it may mean that the corresponding host device 200 is not accessible to the corresponding address. For example, the first accessibility status value may be set to “0” and the second accessibility status value may be set to “1,” but the disclosed technology is not limited thereto.

For example, the accessibility status information included in the accessibility status information field 320 may be constituted by a 4-bit accessibility status value. The accessibility status value constituted by 4 bits may indicate whether maximum four host devices 200 are accessible.

For example, the least significant bit of the accessibility status value included in the accessibility status information field 320 may indicate the accessibility status of the first host device 210. The third bit of the 4-bit accessibility status value may indicate the accessibility status of the second host device 220.

In some implementations, conversely, the most significant bit of the accessibility status value may indicate the accessibility status of the first host device 210, and the second bit may indicate the accessibility status of the second host device 220.

When receiving an access request to a specific address from the first host device 210 or the second host device 220, the controller 110 may control whether a corresponding host device 200 is accessible to the specific address, based on the accessibility status information included in the accessibility status information field 320.

A data area 330 corresponding to the address of the address information field 310 included in the indirect mapping table may exist. The data area 330 may correspond to a part of a memory area physically included in the first memory area 120a.

While managing the address information field 310, the accessibility status information field 320 and the data area 330 corresponding to the address included in the indirect mapping table, as one information, the controller 110 may control the access and operation of the host device 200 to and on the first memory area 120a as a shared memory area.

In some implementations, the indirect mapping table may further include information that sets or indicates the shared status of a corresponding memory area.

For example, as in <EX 2>, the indirect mapping table may include an address information field 310, a shared status information field 340 and an accessibility status information field 320. The controller 110 may manage a data area 330 corresponding to the address of the address information field 310, as one information.

The address information field 310 may include information on an address included in the first memory area 120a.

The shared status information field 340 may include information on the shared status of the corresponding address. In some implementations, the term “shared status” of a specific address can indicate whether the specific address is a memory area that is shared by multiple hosts or dedicated to a specific host.

For example, if the shared status information included in the shared status information field 340 is a first shared status value, the corresponding address may be an address of a shared area. If the shared status information is a second shared status value, the corresponding address may be an address of a non-shared area. The non-shared area may be an area that is allocated to and used by a specific host device 200.

The first shared status value may be set to “1” and the second shared status value may be set to “0,” but the disclosed technology is not limited thereto.

The accessibility status information field 320 may include accessibility status information indicating an accessible host device 200.

When receiving a request for an address included in the first memory area 120a from a host device 200, the controller 110 may process the request from the host device 200, based on shared status information and accessibility status information corresponding to the address included in the indirect mapping table.

In some implementations, the controller 110 may manage a plurality of data areas 330 corresponding to the first memory area 120a using the indirect mapping table. Since a shared memory area is an area that is accessible by the plurality of host devices 200, while setting and managing at least two data areas 330 corresponding to an address, the controller 110 may increase the efficiency of using the memory 120 by the plurality of host devices 200.

For example, as in <EX 3>, the indirect mapping table may include an address information field 310, a shared status information field 340, an accessibility status information field 320 and an overwrite status field 350.

In <EX 3>, the address information field 310, the shared status information field 340 and the accessibility status information field 320 may be used similarly to the method described in <EX 1> and <EX 2>.

The overwrite status information field 350 may include overwrite status information of the data area 330 corresponding to the address of the address information field 310. The overwrite status information may indicate the overwrite status of data in the data area 330 corresponding to the address.

For example, there may be at least two data areas 330 corresponding to an address included in the first memory area 120a. A first data area 331 and a second data area 332 may correspond to the address.

The first data area 331 may mean an area where old data is written, and the second data area 332 may mean an area where new data is written. A time point when data is written to the first data area 331 may be previous to a time point when data is written to the second data area 332.

In some embodiments, an auxiliary data area 370 may be used in an operation of writing data to the first data area 331 and the second data area 332. The size of the auxiliary data area 370 may be smaller than the size of the first data area 331. The size of the auxiliary data area 370 may be smaller than the size of the second data area 332.

In the first memory area 120a, there may be the first data area 331, the second data area 332 and the auxiliary data area 370 corresponding to the address of the address information field 310.

The usage status of the first data area 331 and the second data area 332 may be indicated based on the overwrite status information of the overwrite status information field 350.

For example, if the overwrite status information is a first overwrite status value, it may indicate that overwriting is not progressed in the data area 330 corresponding to the address.

It may indicate a state in which the second data area 332 corresponding to the address is not used and only the first data area 331 is used. Alternatively, it may indicate a state in which both the first data area 331 and the second data area 332 corresponding to the address are not used.

If the overwrite status information is a second overwrite status value, it may indicate that overwriting has been progressed in the data area 330 corresponding to the address. It may indicate a state in which the first data area 331 and the second data area 332 corresponding to the address are used.

The first overwrite status value may be set to “0” and the second overwrite status value may be set to “1,” but the disclosed technology is not limited thereto.

According to the overwrite status information of the overwrite status information field 350, additional information may be required to process a request from a host device 200. The host device 200 may transmit request status information to the memory system 100 to request an access to the first data area 331 or the second data area 332 depending on an overwrite status.

The controller 110 may receive the request status information from the host device 200. The request status information may be received together with a command or may be received separately from a command.

The controller 110 may configure the request status information as a request status information field 360 of the indirect mapping table, and thereby, may perform processing of the request from the host device 200. The controller 110 may control an access to the data area 330 according to the request status information while managing the request status information received from the host device 200 as a partial field of the indirect mapping table or as a separate field.

For example, if the request status information is a first request status value, the controller 110 may control an access to and an operation on the first data area 331. If the request status information is a second request status value, the controller 110 may control an access to and an operation on the second data area 332.

The first request status value may be set to “0” and the second request status value may be set to “1,” but the disclosed technology is not limited thereto.

By controlling the accesses of the plurality of host devices 200 to the first memory area 120a, which is the shared memory area of the memory 120, based on the indirect mapping table, the memory system 100 may improve the efficiency of using a memory area and may prevent the occurrence of an error due to the use of the shared memory area.

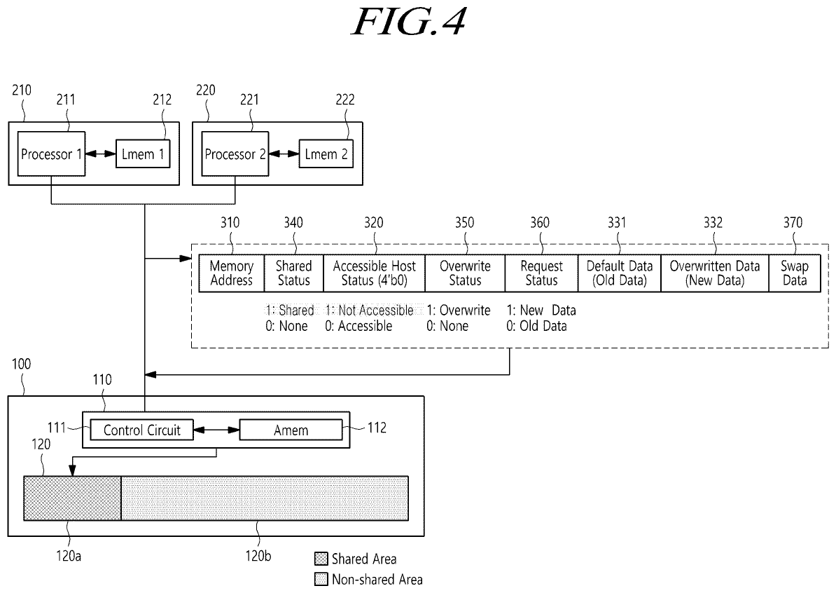

FIGS. 4 to 6 are diagrams illustrating an example method by which the memory system 100 handles read commands based on an embodiment of the disclosed technology.

Referring to FIG. 4, a case where the first host device 210 and the second host device 220 perform data processing using the memory system 100 is illustrated as an example.

Each of the first host device 210 and the second host device 220 may perform data processing using a local memory, and, if necessary, may perform data processing using a part of the memory areas of the memory system 100.

Each of the first host device 210 and the second host device 220 may be allocated and independently use at least a part of the second memory area 120b among the memory areas of the memory 120 included in the memory system 100. In addition, each of the first host device 210 and the second host device 220 may perform data processing while accessing the first memory area 120a of the memory 120.

Depending on a period, at least a part of the first memory area 120a may be accessed by the first host device 210 and the second host device 220, or may be accessed by only one of the first host device 210 and the second host device 220.

When receiving a command for an address included in the first memory area 120a from the first host device 210 or the second host device 220, the controller 110 of the memory system 100 may control the access of the host device 200 to the corresponding address and the command processing of the host device 200 based on the indirect mapping table.

For example, the controller 110 may include a control circuit 111 and an auxiliary memory 112.

The control circuit 111 may manage or control the allocation, access and usage status of a memory area and an operation on the corresponding memory area according to a request from the host device 200.

The auxiliary memory 112 may be located inside the controller 110. In some implementations, the auxiliary memory 112 may be located outside the controller 110.

The auxiliary memory 112 may operate under the control of the control circuit 111, and may store the indirect mapping table. In the present specification, the auxiliary memory 112 may be referred to as an internal memory, and the memory 120 included in the memory system 100 may be referred to as an external memory.

When receiving a command from the host device 200, the control circuit 111 of the controller 110 may check information corresponding to an address according to the command in the indirect mapping table stored in the auxiliary memory 112, and may perform processing of the corresponding command.

For example, referring to FIG. 4, the control circuit 111 may check an address according to a read command received from the host device 200. The control circuit 111 may check the shared status information field 340 and the accessibility status information field 320 corresponding to the address in the indirect mapping table stored in the auxiliary memory 112.

If the shared status information of the shared status information field 340 corresponding to the address is the first shared status value, the control circuit 111 may determine that the corresponding address indicates a memory area that is accessible by the plurality of host devices 200.

If the accessibility status information of the accessibility status information field 320 corresponding to the address is the second accessibility status value, the control circuit 111 may determine that the host device 200 that has transmitted the read command is not accessible to the corresponding address.

Since the host device 200 is not accessible to the corresponding address, the control circuit 111 may transmit an error value to the host device 200 that has transmitted the read command. The error value may be a value indicating that the host device 200 does not have a read right for the corresponding address, and the type of the error value may not be limited to a specific type. Alternatively, the control circuit 111 may provide the host device 200 with a value converted based on data written to a memory area corresponding to the address.

For example, the control circuit 111 may transmit, to the host device 200, a result value of performing a preset operation on data read from the memory area corresponding to the address.

The control circuit 111 may transmit, to the host device 200, a result value of performing a bit operation using a preset value and a preset operator on data read from the memory area corresponding to the address. The control circuit 111 may transmit, to the host device 200, a result value of ANDing all read data and “0.” The memory system 100 may process, without an error, the read command transmitted by the host device 200 that is not accessible to a shared memory area.

When the host device 200 is accessible, the memory system 100 may perform an access to a corresponding address and processing of the command based on the indirect mapping table.

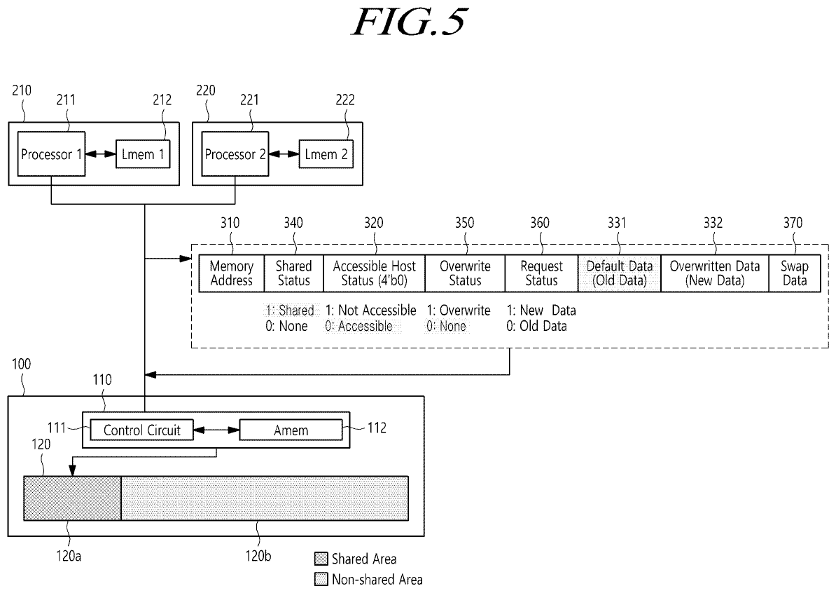

For example, referring to FIG. 5, when receiving a read command from a host device 200, the controller 110 may check whether the host device 200 is accessible, based on the indirect mapping table. Hereinafter, a case where processing of the read command is performed by the controller 110 is described as an example, but this may include processing by the control circuit 111 described above.

If the shared status information of the shared status information field 340 in the indirect mapping table is the first shared status value and the accessibility status information of the accessibility status information field 320 is the first accessibility status value, the controller 110 may determine that the corresponding host device 200 is accessible to a corresponding address.

The controller 110 may check the overwrite status information of the overwrite status information field 350 corresponding to the address.

If the overwrite status information of the overwrite status information field 350 is the first overwrite status value, the controller 110 may determine a state in which overwriting is not performed in the data area 330 corresponding to the address.

The controller 110 may perform a read operation on the first data area 331 between the first data area 331 and the second data area 332 corresponding to the address. As described above as an example, the read operation may be controlled by the controller 110, or the read operation may be controlled by the memory controller which controls the operation of the memory 120, according to an instruction from the controller 110.

The controller 110 may transmit data read from the first data area 331 to the host device 200 that has transmitted the read command.

If the data area 330 corresponding to the address is in an overwritten state according to the overwrite status information of the overwrite status information field 350, the controller 110 may process the read command by checking request status information transmitted by the host device 200.

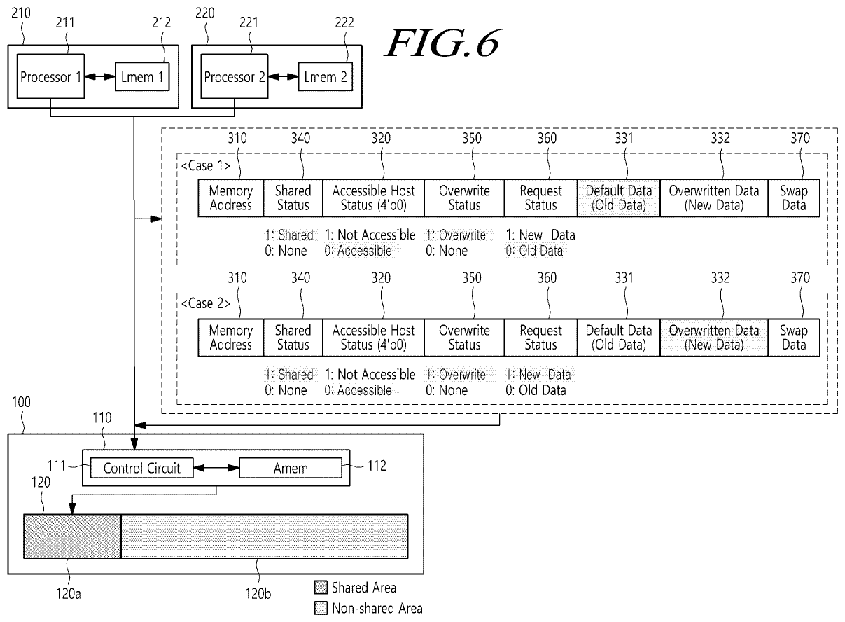

For example, referring to FIG. 6, when receiving a read command from a host device 200, the controller 110 may check the shared status information field 340, the accessibility status information field 320 and the overwrite status information field 350 in the indirect mapping table.

If the overwrite status information of the overwrite status information field 350 is the second overwrite status value, the controller 110 may determine that the data area 330 corresponding to a corresponding address is in an overwritten state.

If the overwrite status information is the second overwrite status value, the controller 110 may select a data area 330 to be read according to the read command, based on request status information transmitted by the host device 200.

For example, as in <Case 1>, if the overwrite status information is the second overwrite status value, the controller 110 may check the request status information of the host device 200.

If the request status information is the first request status value, the controller 110 may read data written to the first data area 331 of the data area 330 corresponding to the address. The controller 110 may transmit the data read from the first data area 331 to the host device 200.

For another example, as in <Case 2>, if the request status information is the second request status value, the controller 110 may read data written to the second data area 332 of the data area 330 corresponding to the address. The controller 110 may transmit the data read from the second data area 332 to the host device 200.

The controller 110 may manage at least two data areas 330 corresponding to the address of a memory area included in the first memory area 120a using the overwrite status information field 350 of the indirect mapping table.

The controller 110 may control a read operation for data written to at least two data areas 330 based on overwrite status information and request status information received from a host device 200. By managing data written to each address in the first memory area 120a accessible by the plurality of host devices 200 by classifying the data into old data and new data, a memory area which is accessible by the plurality of host devices 200 may be efficiently managed.

The controller 110 may manage an overwritten state by setting the overwrite status information of the overwrite status information field 350 during a write operation for an address included in the first memory area 120a.

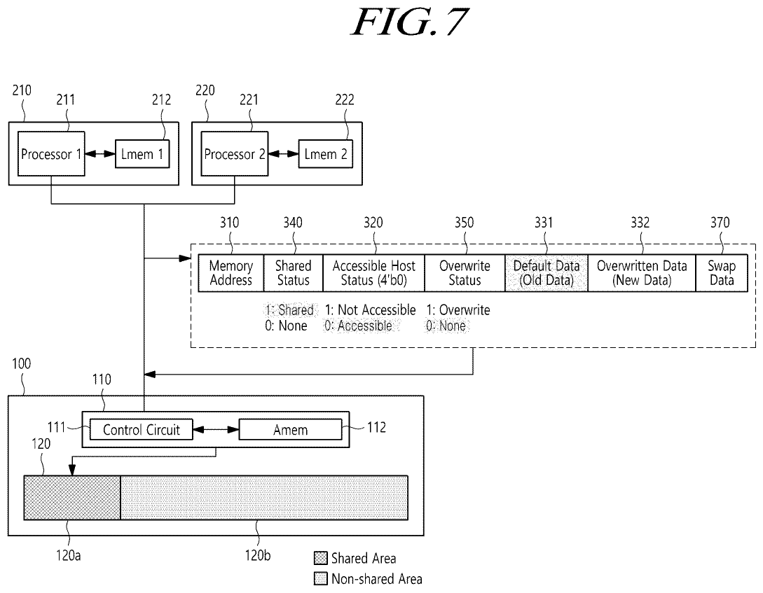

FIGS. 7 to 9 are diagrams illustrating an example method by which the memory system 100 handles write commands based on an embodiment of the disclosed technology.

Referring to FIG. 7, the memory system 100 may receive a write command from a host device 200.

The controller 110 of the memory system 100 may check an address according to the write command. When the address is included in the first memory area 120a of the memory 120, the controller 110 may check the indirect mapping table.

The controller 110 may check the shared status information field 340, the accessibility status information field 320 and the overwrite status information field 350 corresponding to the address in the indirect mapping table.

If the accessibility status information of the accessibility status information field 320 is the second accessibility status value, the controller 110 may determine that an access by the corresponding host device 200 is not possible and may transmit an error value to the host device 200.

If the accessibility status information of the accessibility status information field 320 is the first accessibility status value, the controller 110 may determine that an access by the corresponding host device 200 is possible. The controller 110 may check the overwrite status information of the overwrite status information field 350.

If the write command is the first write command for a data area 330 corresponding to the address according to the write command, the overwrite status information field 350 may be in an unset state. It may be a state in which the overwrite status information of the overwrite status information field 350 is set to the first overwrite status value.

The controller 110 may control a write operation on the first data area 331 among the first data area 331 and the second data area 332 corresponding to the address if it is the first write to the corresponding address. The data from the write command of the host device 200 may be written to the first data area 331 corresponding to the address.

When the data is written to the first data area 331, the controller 110 may set the overwrite status information of the overwrite status information field 350 corresponding to the address, to the first overwrite status value.

Alternatively, the controller 110 may select a data area 330 to which data is to be written, depending on the attribute of the write command received from the host device 200.

For example, when the write command is a normal write command, the controller 110 may write data to the first data area 331 corresponding to the address according to the write command. When the write command is an overwrite command, the controller 110 may write data to the second data area 332 corresponding to the address according to the write command.

The host device 200 may distinguishably transmit a normal write command and an overwrite command through a write command.

Alternatively, the host device 200 may distinguishably transmit a normal write command and an overwrite command using the request status information. For example, if the request status information is the first request status value, writing to the first data area 331 may be requested, and if the request status information is the second request status value, writing to the second data area 332 may be requested.

When receiving a write command after first writing to the data area 330 corresponding to the address or receiving an overwrite command from the host device 200, the controller 110 may control a write operation on the second data area 332 corresponding to the address.

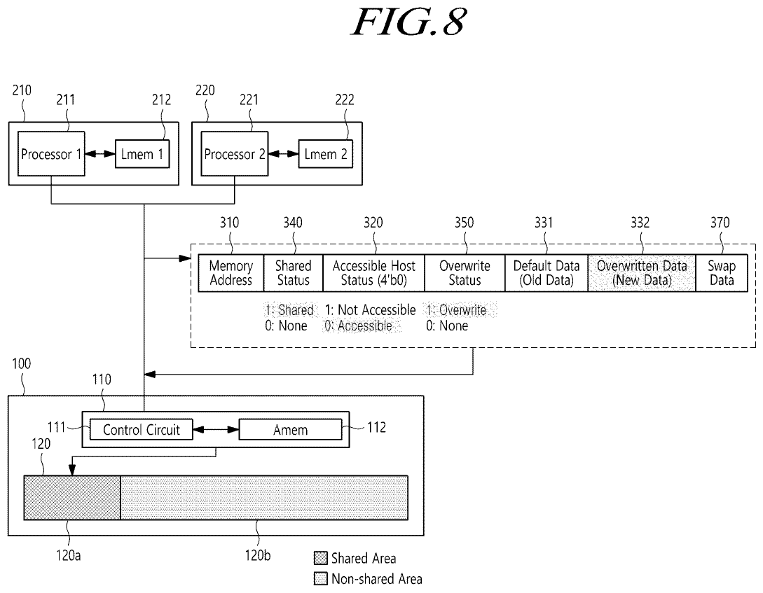

For example, referring to FIG. 8, the controller 110 may receive a write command for an address for which data is written to the first data area 331.

The controller 110 may check the overwrite status information of the overwrite status information field 350 and select a data area 330 to which data is written.

When the overwrite status information of the overwrite status information field 350 is set to the first overwrite status value, the controller 110 may determine that data is written to the first data area 331.

The controller 110 may write data according to the write command received from the host device 200 to the second data area 332 corresponding to the address. After writing data to the second data area 332, the controller 110 may set the overwrite status information of the overwrite status information field 350 corresponding to the address, to the second overwrite status value.

When the overwrite status information of the overwrite status information field 350 is set to the second overwrite status value, the data area 330 corresponding to the address may be managed as being in an overwritten state.

When a read command for the corresponding address is received, the controller 110 may check request status information according to the read command and process the read command. When a write command for the corresponding address is received, the controller 110 may maintain only the data written to the second data area 332 between data written to the first data area 331 and the second data area 332, and may perform a write operation according to the newly received write command.

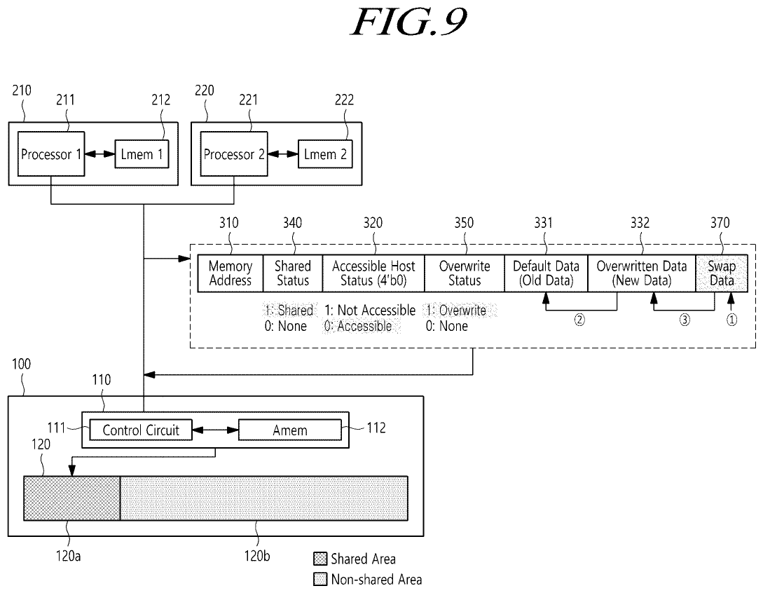

For example, referring to FIG. 9, when receiving a write command from a host device 200, the controller 110 may check the overwrite status information field 350 corresponding to an address according to the write command in the indirect mapping table.

If the overwrite status information of the overwrite status information field 350 is the second overwrite status value, the controller 110 may determine a state in which data is written to the first data area 331 and the second data area 332 corresponding to the address.

The controller 110 may write data according to the write command to the auxiliary data area 370 corresponding to the address (\textcircled{1}).

When the data is written to the auxiliary data area 370, the controller 110 may copy data written to the second data area 332 to the first data area 331 (\textcircled{2}). The controller 110 may copy the data written to the auxiliary data area 370 to the second data area 332 (\textcircled{3}).

By using the overwrite status information included in the overwrite status information field 350 of the indirect mapping table and the first data area 331 and the second data area 332, the controller 110 may manage two data most recently written to a memory area corresponding to an address shared by the plurality of host devices 200. In some implementations, at least three data areas 330 may correspond to an address included in the first memory area 120a, and in this case, the overwrite status information of the overwrite status information field 350 is constituted by at least 2 bits, and a write operation on the at least three data areas 330 may be controlled.

In this way, the controller 110 may control the accesses and operations of the plurality of host devices 200 to and on the first memory area 120a of the memory 120 using the indirect mapping table.

Since the controller 110 manages the second memory area 120b by allocating the second memory area 120b to one host device 200 among the plurality of host devices 200, the controller 110 may manage an access and an operation to and for an address received from the host device 200, based on the address, rather than using an indirect mapping table.

Alternatively, since the first memory area 120a and the second memory area 120b may be variably set and managed depending on a usage status, an access to the second memory area 120b may also be controlled using an indirect mapping table.

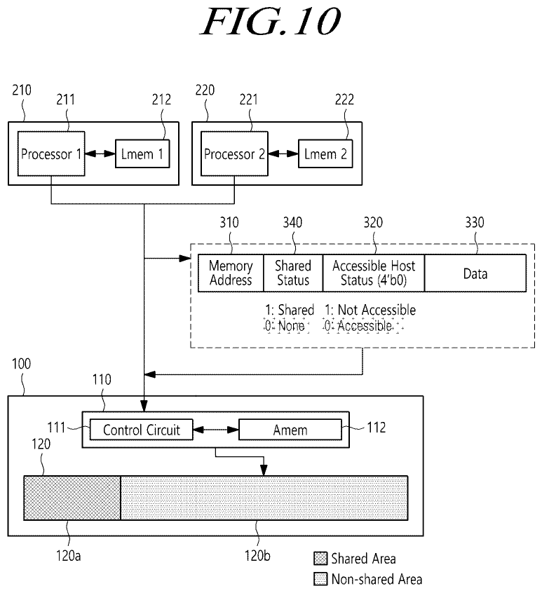

FIG. 10 is a diagram illustrating an example of the memory system 100 that manages access to a non-shared memory area based on an embodiment of the disclosed technology.

Referring to FIG. 10, when receiving a command from a host device 200, the controller 110 of the memory system 100 may check the indirect mapping table.

In the indirect mapping table, the controller 110 may check the shared status information field 340 corresponding to an address according to the command. If the shared status information of the shared status information field 340 is the second shared status value, the controller 110 may determine a state in which the corresponding address is not shared. The corresponding address may be included in the second memory area 120b.

The controller 110 may process the command of the host device 200 by accessing the corresponding address in the second memory area 120b.

Alternatively, in the case of using the indirect mapping table, the controller 110 may process the command by checking the accessibility status information field 320.

The second memory area 120b may not be shared by the plurality of host devices 200 and may be used by being allocated to a specific host device 200. The accessibility status information of the accessibility status information field 320 may be set so that only the host device 200 allocated the corresponding address among the plurality of host devices 200 is accessible to the corresponding address.

For example, when the accessibility status information is set to a 4-bit accessibility status value and the corresponding address is allocated to the first host device 210, only the most significant bit or the least significant bit of the 4-bit accessibility status value may be set to the first accessibility status value, and the remaining bits may be set to the second accessibility status value.

The overwrite status information field 350 may not be set or may be managed by being set to a default value.

The controller 110 may manage the first memory area 120a and the second memory area 120b using the indirect mapping table, and may variably set and manage the first memory area 120a and the second memory area 120b in the memory 120.

In this way, since the controller 110 of the memory system 100 manages the accesses and operations of the plurality of host devices 200 to and on the first memory area 120a based on the indirect mapping table, it is possible to improve the efficiency of using the memory areas of the memory system 100 used by the plurality of host devices 200 and prevent an operation error due to the use of a shared memory area.

Only a few embodiments and examples are described. Enhancements and variations of the disclosed embodiments and other embodiments can be made based on what is described and illustrated in this patent document.

What is claimed is:

1. A memory system comprising:
one or more memory devices, each memory device including a first memory area and a second memory area, wherein a number of host devices that are accessible to the first memory area is equal to or greater than a number of host devices that are accessible to the second memory area; and
a controller configured to, upon receiving a first command for a first address included in the first memory area, control an operation according to the first command based on an indirect mapping table that includes:
shared status information indicating a shared status of the first address to indicate whether the first address is a memory area that is shared by a plurality of host devices or dedicated to a specific host device;
accessibility status information indicating whether a specific host device is accessible to the first address; and
overwrite status information indicating usage statuses of at least two data areas corresponding to the first address to indicate whether data in the at least two data areas is overwritten data.

2. The memory system according to claim 1, wherein upon receiving a read command as the first command, the controller checks the overwrite status information for the first address, and upon determination that the overwrite status information corresponds to a first overwrite status value, performs a read operation on a first data area of the at least two data areas corresponding to the first address.

3. The memory system according to claim 2, wherein the controller: checks request status information according to the first command upon determination that the overwrite status information corresponds to a second overwrite status value; performs a read operation on the first data area upon determination that the request status information corresponds to a first request status value; and performs a read operation on a second data area of the at least two data areas corresponding to the first address upon determination that the request status information corresponds to a second request status value.

4. The memory system according to claim 3, wherein a point in time at which data is written to the first data area precedes a point in time at which data is written to the second data area.

5. The memory system according to claim 1, wherein upon receiving a write command as the first command, in a case that the write command is a first write command for the first address, the controller performs a write operation on a first data area of the at least two data areas corresponding to the first address, and sets the overwrite status information for the first address to a first overwrite status value.

6. The memory system according to claim 5, wherein in a case that the write command is a write command for the first address subsequent to the first write command, the controller: performs a write operation on a second data area corresponding to the first address; and sets the overwrite status information for the first address to a second overwrite status value.

7. The memory system according to claim 6, wherein an auxiliary data area corresponding to the first address has a size that is smaller than at least one of a size of the first data area or a size of the second data area.

8. The memory system according to claim 7, wherein the controller: performs a write operation on the auxiliary data area according to the first command; copies data from the second data area to the first data area; and copies data from the auxiliary data area to the second data area.

9. The memory system according to claim 1, wherein
upon receiving a read command as the first command, the controller checks the accessibility status information for the first address, and in a case that a host device that transmits the first command is accessible to the first address, the controller performs a read operation on a data area corresponding to the first address, and
in a case that the host device that transmits the first command is not accessible to the first address, the controller provides the host device with a result value of performing a bit operation using a preset value and a preset operator on data stored in the data area corresponding to the first address.

10. The memory system according to claim 1, wherein
upon receiving a write command as the first command, the controller checks the accessibility status information for the first address, and in a case that a host device that transmits the first command is accessible to the first address, the controller performs a write operation on a data area corresponding to the first address, and
in a case that the host device that transmits the first command is not accessible to the first address, the controller returns an error value to the host device.

11. The memory system according to claim 1, wherein in a case that the shared status information for the first address is a first shared status value and a host device that transmits the first command is accessible to the first address according to the accessibility status information for the first address, the controller performs an operation according to the first command.

12. The memory system according to claim 1, wherein upon receiving a second command for a second address included in the second memory area, the controller controls an operation according to the second command, and a data area of the at least two data areas corresponding to the second address is allocated to a host device that transmits the second command.

13. The memory system according to claim 12, wherein the shared status information for the first address included in the first memory area is set to a first shared status value, and the shared status information for the second address included in the second memory area is set to a second shared status value.

14. The memory system according to claim 13, wherein the accessibility status information for the second address is set as inaccessible to the second address for a host device other than the host device that transmits the second command.

15. A memory system comprising:
one or more memory devices, each memory device including a first memory area and a second memory area; and
a controller configured to:
control, upon receiving a first command for a first address included in the first memory area, an operation according to the first command based on an indirect mapping table that includes information on at least two data areas in the first memory area corresponding to the first address; and
control, upon receiving a second command for a second address included in the second memory area, an operation according to the second command on one data area in the second memory area corresponding to the second address.

16. The memory system according to claim 15, wherein the indirect mapping table includes shared status information indicating a shared status of the first address to indicate whether the first address is a memory area that is shared by multiple host devices or dedicated to a specific host device, accessibility status information indicating whether a specific host device is accessible to the first address, and overwrite status information indicating usage statuses of the at least two data areas corresponding to the first address to indicate whether data in the at least two data areas is overwritten data.

17. The memory system according to claim 15, wherein a number of host devices accessible to the first memory area is equal to or greater than a number of host devices accessible to the second memory area.

18. A controller comprising:
an internal memory device configured to store an indirect mapping table including shared status information, accessibility status information and overwrite status information for at least a part of a memory area included in an external memory device; and
a control circuit configured to: upon receiving a command from an external device, check the shared status information, the accessibility status information and the overwrite status information corresponding to an address according to the command in the indirect mapping table; and perform an operation according to the command on the external memory device.

19. The controller according to claim 18, wherein the control circuit performs, in a case that the overwrite status information corresponds to a first overwrite status value, an operation according to the command on a first data area corresponding to the address.

20. The controller according to claim 19, wherein the controller: in a case that the overwrite status information corresponds to a second overwrite status value, checks request status information according to the command; in a case that the request status information corresponds to a first request status value, performs an operation according to the command on the first data area; and in a case that the request status information corresponds to a second request status value, performs an operation according to the command on a second data area corresponding to the address.
